(19) United States
(12) Patent Application Publication
(10) Pub. No.: US 2012/0177321 A1
(43) Pub. Date: Jul. 12, 2012

(54) LIGHT-RECEIVING DEVICE

(75) Inventors: Ryo Kuwahara, Kanagawa (JP); Ken Ashizawa, Kanagawa (JP); Toru Hirayama, Kanagawa (JP); Keiji Satoh, Kanagawa (JP); Taketo Kawano, Kanagawa (JP)

(73) Assignee: SUMITOMO ELECTRIC DEVICE INNOVATIONS, INC., Yokohama-shi (JP)

(21) Appl. No.: 13/342,519

(22) Filed: Jan. 3, 2012

(30) Foreign Application Priority Data
Jan. 7, 2011 (JP) 2011-001622

(51) Int. Cl. G02B 6/32

(52) U.S. Cl. 385/35; 385/33

(57) ABSTRACT

A light-receiving device including: a lens; and a light-receiving element optically coupled to the lens, a plurality of optical path divided by the lens crossing each other in a position of between the lens and the light-receiving element.

### CROSS-REFERENCE TO RELATED APPLICATION

This application is based upon and claims the benefit of priority of the prior Japanese Patent Application No. 2011-001622, filed on Jan. 7, 2011, the entire contents of which are incorporated herein by reference.

### BACKGROUND

(i) Technical Field

The present invention relates to a light-receiving device.

(ii) Related Art

In an optical semiconductor device such as an optical receiver, a light-receiving element receives an optical signal emitted from an emission edge of an optical fiber. It is preferable that an active diameter is small, in order to operate a light-receiving element at high speed. On the other hand, when a light intensity peak on a light-receiving face of a light-receiving element gets higher, current density of the area gets higher. This results in space-charge effect (saturation in light-receiving element). Japanese Patent Application Publication No. 05-224101, Japanese Patent Application Publication No. 06-21485 and Japanese Patent Application Publication No. 08-18077 disclose a defocusing technology as a measure.

When a beam diameter is enlarged through the defocusing, the peak light intensity on the light-receiving face gets lower relatively. Thus, local increasing of current density on the light-receiving face is restrained, and the occurrence of the space-charge effect is restrained. However, when the beam diameter is enlarged, light may leak out of the light-receiving face, and an optical coupling efficiency may be reduced.

### SUMMARY

It is an object of the present invention to provide a light-receiving device achieving both restraint of space-charge effect of a light-receiving element and high optical coupling efficiency of a light-receiving element.

According to an aspect of the present invention, there is provided a light-receiving device including: a lens; and a light-receiving element optically coupled to the lens, a plurality of optical path divided by the lens crossing each other in a position of between the lens and the light-receiving element.

According to another aspect of the present invention, there is provided a light-receiving device including: a lens; and a light-receiving element optically coupled to the lens, an incoming light through the lens having a plurality of peak intensities on a light-receiving face of the light-receiving element.

### BRIEF DESCRIPTION OF THE DRAWINGS

FIG. 1 illustrates a cross sectional view for describing an overall structure of an optical semiconductor device in accordance with a comparative example;

FIG. 2A and FIG. 2B illustrate a schematic view of a beam diameter of an optical signal passing through a lens;

FIG. 3 illustrates light intensity distribution of an optical signal received by a light-receiving face of a light-receiving element;

FIG. 4A illustrates three dimensional light intensity distribution of “Peak” of FIG. 3;

FIG. 4B illustrates contour lines of the light intensity distribution of “Peak”;

FIG. 5A illustrates three dimensional light intensity distribution of “Defocus 4” of FIG. 3;

FIG. 5B illustrates contour lines of the light intensity distribution of “Defocus 4” of FIG. 3;

FIG. 6 illustrates a light intensity distribution during a defocusing;

FIG. 7 illustrates a relationship between light intensity at a center of an optical signal and an optical coupling efficiency;

FIG. 8 illustrates a cross sectional view for describing an overall structure of an optical semiconductor device in accordance with an embodiment;

FIG. 9A and FIG. 9B illustrate a schematic view for describing a positional relationship between an emission edge of an optical fiber, a lens and a light-receiving element;

FIG. 10 illustrates a case where a plurality of peaks appear;

FIG. 11 illustrates an optical coupling efficiency;

FIG. 12A and FIG. 12B illustrate another example of a light receiving element;

FIG. 13 illustrates a cross sectional view for describing an overall structure of an optical semiconductor device in accordance with a second modified embodiment;

FIG. 14A illustrates three dimensional light intensity distribution of the embodiment;

FIG. 14B illustrates contour lines of light intensity distribution of FIG. 14A;

FIG. 15 illustrates experimental results; and

FIG. 16 illustrates an example of a structure of an optical system.

### DETAILED DESCRIPTION

A description will be given of a comparative example.

### Comparative Example

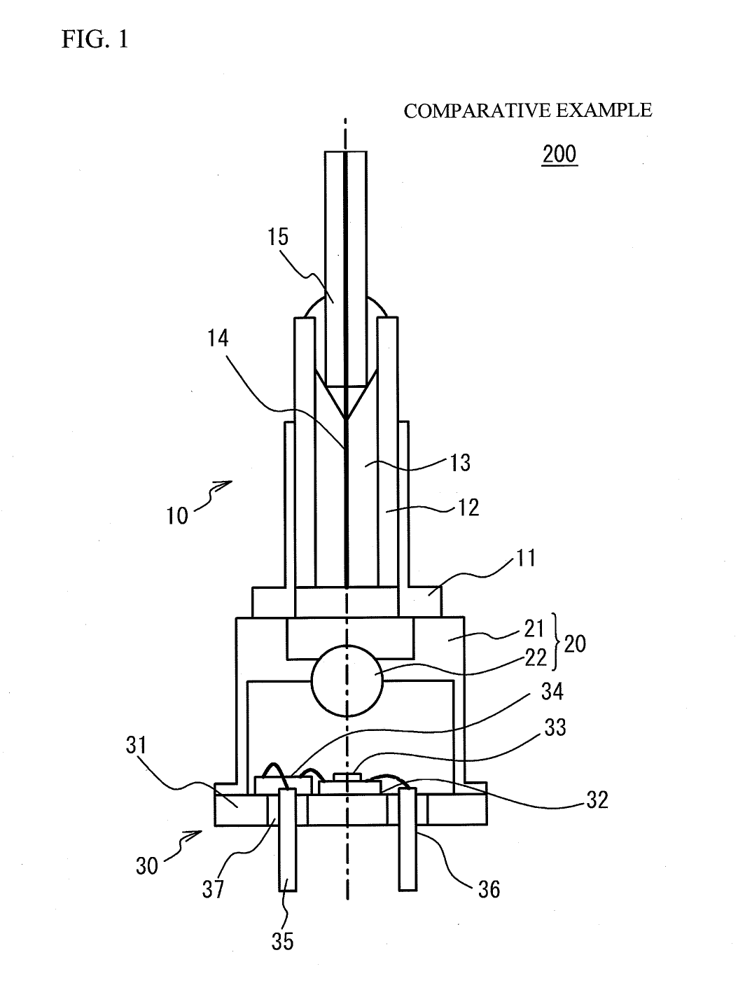

FIG. 1 illustrates a cross sectional view for describing an overall structure of an optical semiconductor device 200 in accordance with the comparative example. As illustrated in FIG. 1, the optical semiconductor device 200 has a light input portion 10, a light focus portion 20 and a light-receiving portion 30. An optical signal input from the light input portion 10 is a single wavelength light signal. The light focus portion 20 focuses the optical signal. The light-receiving portion 30 receives the focused optical signal.

In the light input portion 10, a holder 11 fixes a ferrule clasp 12. A ferrule 13 is inserted into the ferrule clasp 12. An optical fiber 14 penetrates the ferrule 13. Outside the ferrule 13, the optical fiber 14 is covered with a cover member 15. An emission edge of the ferrule 13 and the optical fiber 14 is vertically cut with respect to an optical axis of the optical fiber 14.

A cap 21 fixes a lens 22 in the light focus portion 20. The lens 22 is arranged so that a center of the lens 22 overlaps with the optical axis of the optical fiber 14. The lens 22 is not limited specifically. The lens 22 is, for example, a spherical lens.

In the light-receiving portion 30, a sub mount 32 is provided on a stem 31, and a light-receiving element 33 is mounted on the sub mount 32. The light-receiving element 33 has only to be a semiconductor light-receiving element (a photo diode). The light-receiving element 33 may be a front-face illuminated light-receiving element or may be a back-face illuminated light-receiving element. An outputting terminal of the light-receiving element 33 is coupled to a lead 35 via a pre-amplifier 34. A lead 36 is coupled to a power supply terminal of the light-receiving element 33. An insulating member 37 such as a glass is provided between the leads 35 and 36 and the stem 31.

An optical signal transmitting in the optical fiber 14 is emitted to the lens 22 from an emission edge of the optical fiber 14. The lens 22 adjusts a beam diameter inputting to a light-receiving face of the light-receiving element 33. The light-receiving element 33 converts an incoming light into an electrical signal through photoelectric conversion. The pre-amplifier 34 amplifies the electrical signal output from the light-receiving element 33.

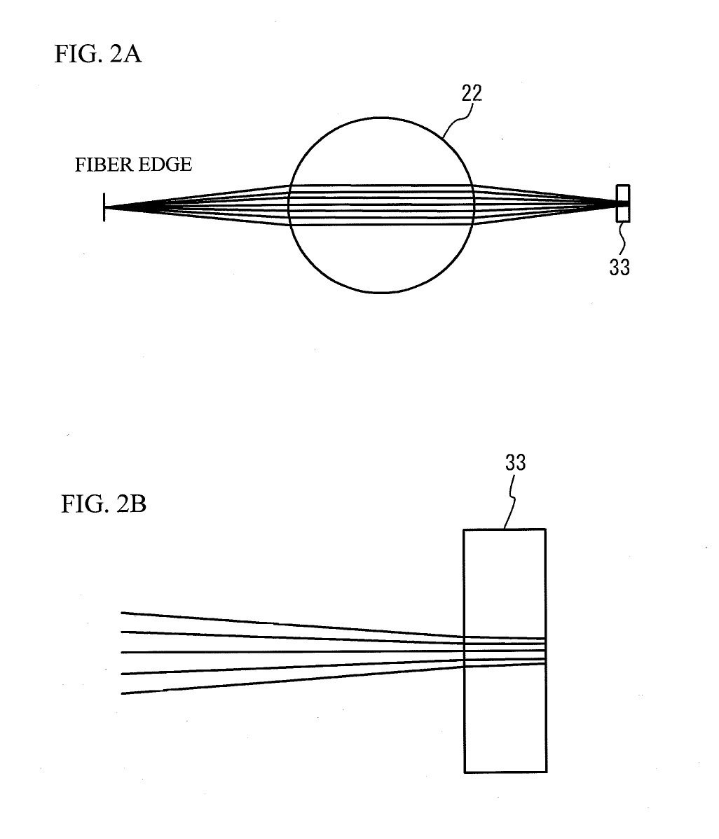

FIG. 2A illustrates a schematic view of the beam diameter of the optical signal passing through the lens 22. FIG. 2B illustrates an enlarged view around the light-receiving element 33. As illustrated in FIG. 2A, a spherical lens is used as the lens 22. As illustrated in FIG. 2B, a back-face illuminated photo diode is used as the light-receiving element 33.

The beam diameter of the optical signal output from the emission edge of the optical fiber 14 gets larger in a transmitting direction of the optical signal with the optical axis being a center. Thus, the beam diameter forms a Gaussian distribution. In the comparative example, the lens 22 is provided so that the optical axis of the optical signal passes through the center of the lens 22. That is, the optical axis of the optical signal is vertical with respect to a tangential plane of the lens 22. In this case, comatic aberration is avoided. Therefore, the optical signal passing through the lens 22 is distributed with the optical axis of the optical signal being a symmetrical optical axis. The lens 22 collects a light from the optical fiber 14 and adjusts the beam diameter of the optical signal received by the light-receiving element 33 to a predetermined value.

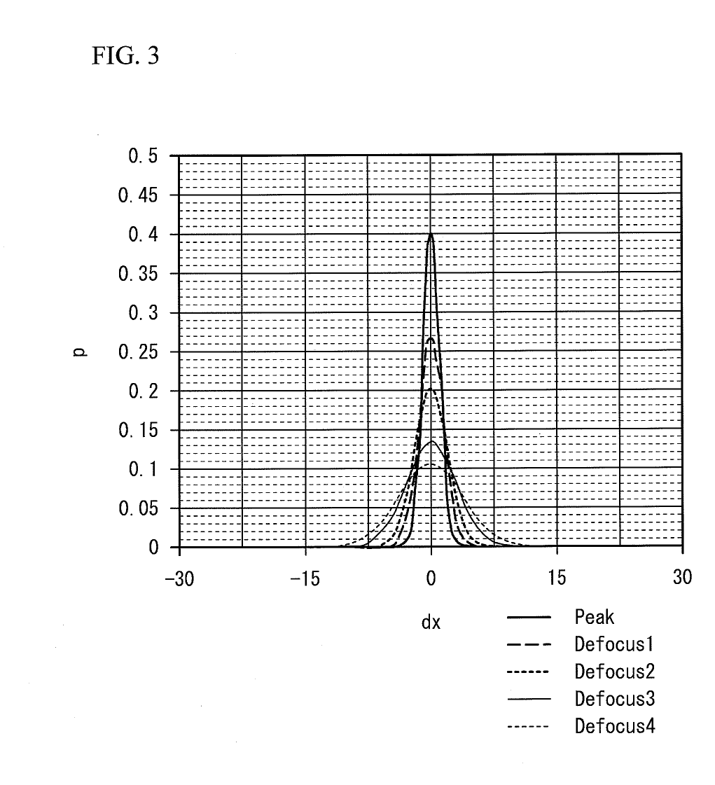

FIG. 3 illustrates light intensity distribution of an optical signal received by the light-receiving face of the light-receiving element 33. In FIG. 3, a horizontal axis indicates a distance (μm) from the center of the optical signal. A vertical axis indicates the light intensity (relative light intensity with respect to total amount of light). FIG. 3 illustrates light intensity distribution of an optical signal in which a beam diameter is changed through defocusing. “Peak” indicates an optical signal without defocusing. “Defocus 1” to “Defocus 4” indicate an optical signal with defocusing. As illustrated in FIG. 3, the light intensity of the optical signal is the highest at the center of the optical signal.

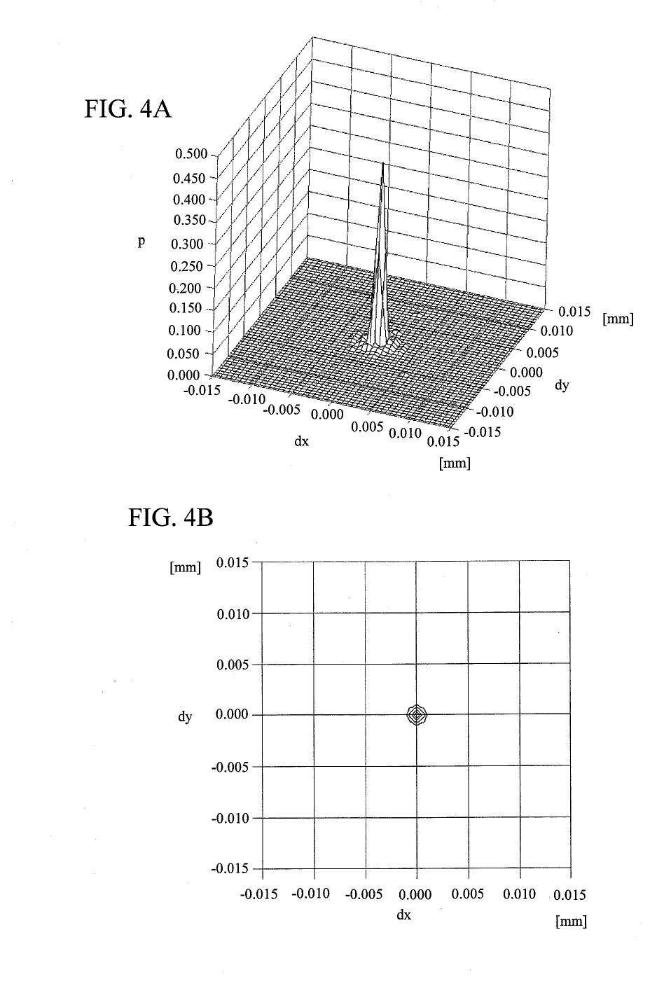

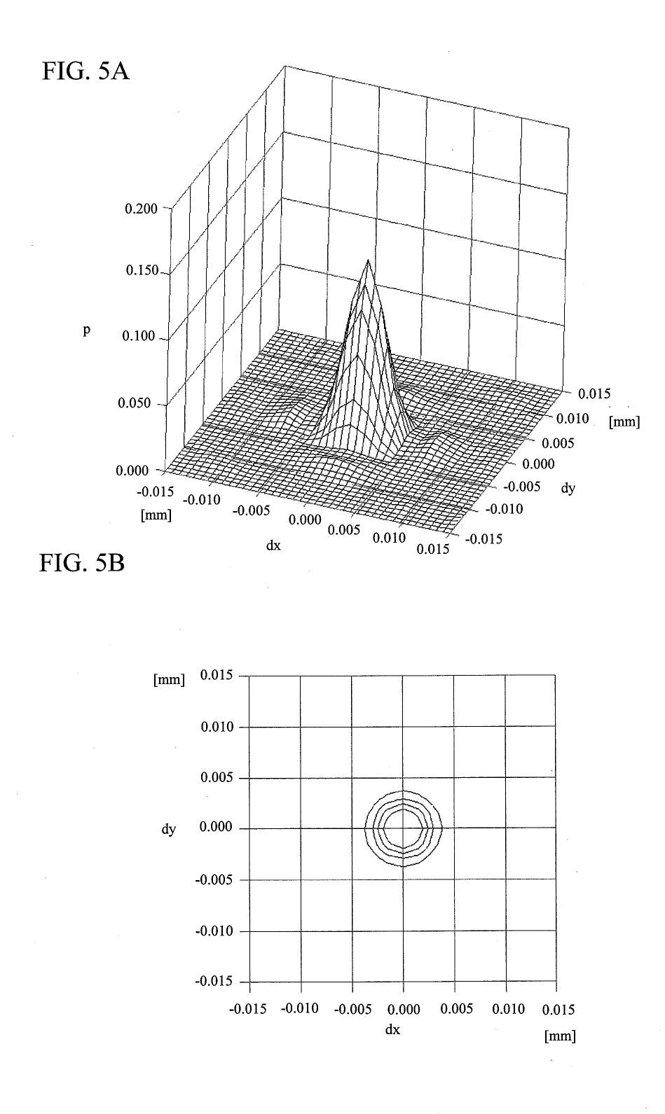

FIG. 4A illustrates three dimensional light intensity distribution of “Peak” of FIG. 3. FIG. 4B illustrates contour lines of the light intensity distribution of “Peak”. FIG. 5A illustrates three dimensional light intensity distribution of “Defocus 4” of FIG. 3. FIG. 5B illustrates contour lines of the light intensity distribution of “Defocus 4” of FIG. 3. In FIG. 4A and FIG. 5A, an x-axis (dx) and a y-axis (dy) indicate two-dimensional directions of the light-receiving face. A z-axis (p) indicates the light intensity. The contour lines of FIG. 4A and FIG. 5A indicate five steps between a peak and a bottom. In FIG. 4B and FIG. 5B, an x-axis (dx) and a y-axis (dy) indicate two-dimensional directions of the light-receiving face.

As illustrated in FIG. 3 through FIG. 5B, when the beam diameter gets smaller, the light intensity distribution places a disproportionate emphasis on the center of the optical signal, and the light intensity at the center of the optical signal gets larger. On the other hand, when the beam diameter gets larger, the light intensity distribution diffuses outward from the center of the optical signal, and the light intensity at the center of the optical signal gets smaller.

When the light intensity exceeds a predetermined limit value, space-charge effect occurs in the light-receiving element 33. It is therefore preferable that the beam diameter is increased through defocusing so that a maximum value of the light intensity is the limit value or less. However, in this case, the light intensity far from the center of the optical signal increases as the light intensity at the center of the optical signal decreases.

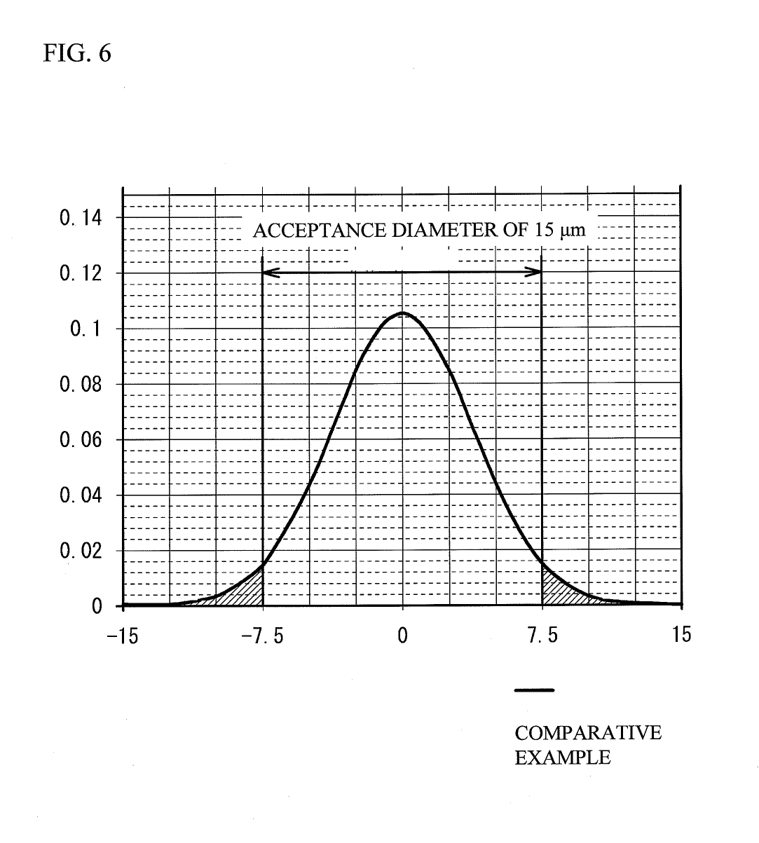

FIG. 6 illustrates the light intensity distribution during the defocusing. In FIG. 6, a horizontal axis indicates a distance (μm) from the center of an optical signal, and a vertical axis indicates the light intensity. In FIG. 6, the light intensity at a position where the distance from the center of an optical signal is larger than 7.5 μm is a predetermined value or more. An optical coupling efficiency of the light-receiving element 33 is reduced when the light-receiving diameter of the light-receiving element 33 is 15 μm, because the optical coupling efficiency of the light-receiving element 33 is proportional to an integral value of the light intensity of FIG. 6. In this way, when the beam diameter gets larger, the optical coupling efficiency gets lower.

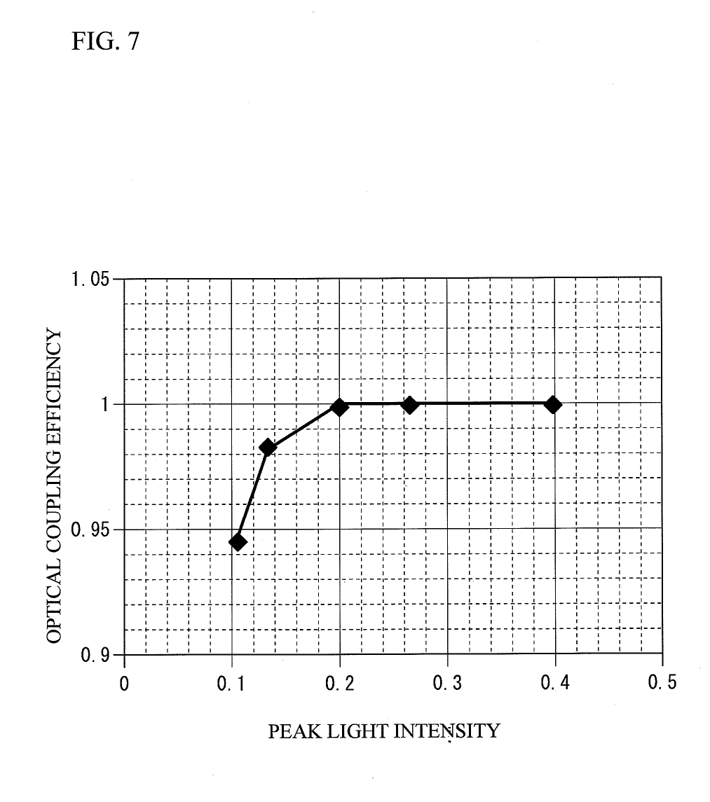

FIG. 7 illustrates a relationship between the light intensity at the center of an optical signal (hereinafter referred to as a peak light intensity) and the optical coupling efficiency. In FIG. 7, a horizontal axis indicates the peak light intensity, and a vertical axis indicates the optical coupling efficiency. As illustrated in FIG. 7, when the peak light intensity is large, the optical coupling efficiency indicates approximately “1”. This is because the beam diameter gets smaller. In contrast, when the peak light intensity is small, the optical coupling efficiency gets smaller. This is because the beam diameter gets larger, and light leaks from the light-receiving face.

As mentioned above, in the optical semiconductor device 200 in accordance with the comparative example, the space-charge effect is not restrained when the beam diameter is small, and the optical coupling efficiency gets smaller when the beam diameter is large. Therefore, the optical semiconductor device 200 of the comparative example cannot achieve both the restraint of the space-charge effect and the high optical coupling efficiency of a light-receiving element.

### Embodiment

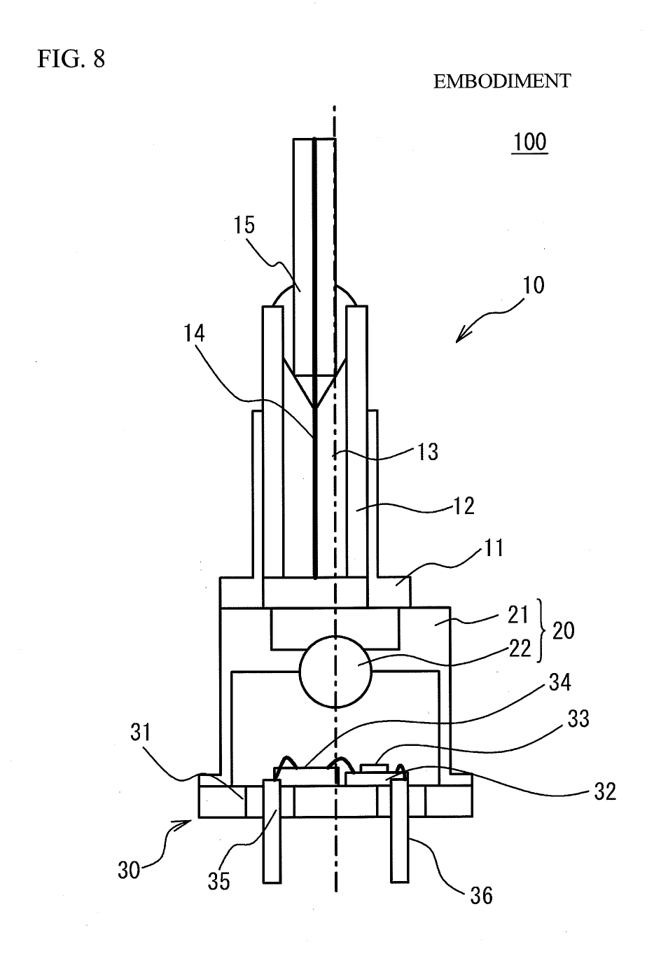

FIG. 8 illustrates a cross sectional view for describing an overall structure of an optical semiconductor device 100 in accordance with an embodiment. As illustrated in FIG. 8, the optical semiconductor device 100 is different from the optical semiconductor device 200 of FIG. 1 in positions of the lens 22 and the light-receiving element 33 with respect to the optical axis of the optical fiber 14. The same components as those illustrated in FIG. 8 have the same reference numerals as FIG. 1.

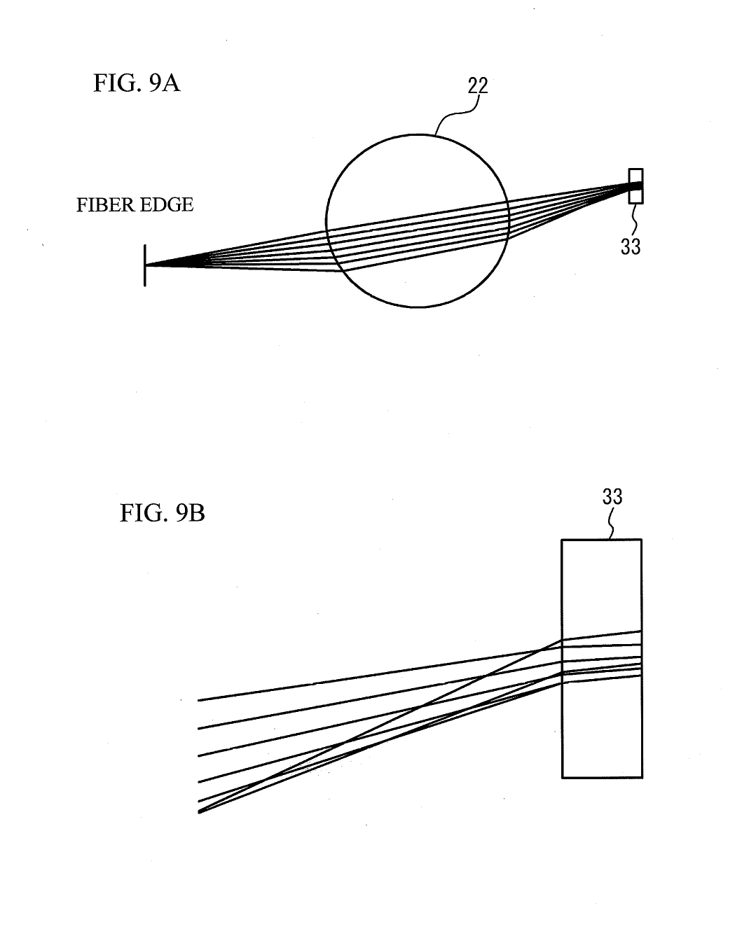

FIG. 9A illustrates a schematic view for describing a positional relationship between an emission edge of the optical fiber 14, the lens 22 and the light-receiving element 33. FIG. 9B illustrates an enlarged view around the light-receiving element 33. As illustrated in FIG. 9A, in the embodiment, the center position of the lens 22 has an offset with respect to optical path of an optical signal emitted from the emission edge of the optical fiber 14. Therefore, in the embodiment, the optical axis of the optical signal emitted from the optical fiber 14 passes through off the center of the lens 22. In other words, the optical axis of the optical signal is not vertical with respect to a tangential plane of the lens 22. In this case, the optical signal passing through the lens 22 is distributed asymmetrically with respect to the optical axis of the optical signal because of comatic aberration and spherical aberration.

One of optical paths of an optical signal emitted from the lens 22 is hereinafter referred to as a first optical path, and another optical path is referred to as a second optical path. When the first optical path and the second optical path cross with each other between the lens 22 and the light-receiving face of the light-receiving element 33, an optical signal passing on the first optical path and an optical signal passing on the second optical path interfere with each other. In this case, the optical signal passing on the first optical path and the optical signal passing on the second optical path strengthen with each other or weaken with each other according to the phase difference, because the optical path of the optical signal emitted from the emission edge of the optical fiber 14 has an offset with respect to the center of the lens 22, passes through the lens 22, and emitted from the lens 22. As a result, a plurality of peaks appear in the light intensity distribution on the light-receiving face of the light-receiving element 33.

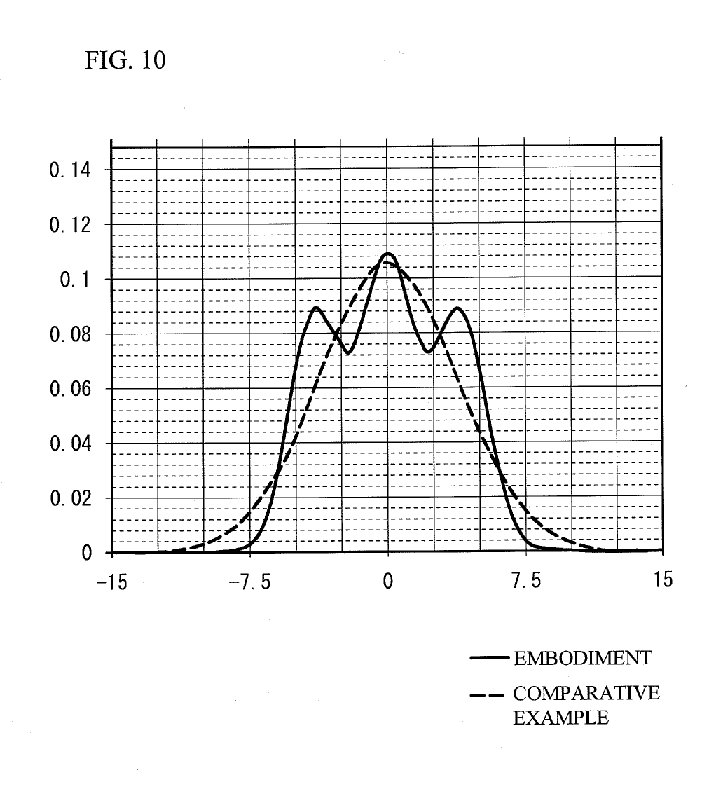

FIG. 10 illustrates the case where a plurality of peaks appear. In FIG. 10, a horizontal axis indicates a distance (μm) from a center of an optical signal, and a vertical axis indicates light intensity. FIG. 10 also illustrates the light intensity distribution of the comparative example. As illustrated in FIG. 10, when a plurality of peaks appear in the light intensity distribution, the light intensity places disproportionate emphasis on a center of an optical signal. Thus, light intensity off the center of the optical signal is reduced. Therefore, even if the maximum value of the light intensity is adjusted to be a limitation value or less, light intensity out of the light-receiving face of the light-receiving element 33 is reduced. The light intensity of the central peak is 0.12 or less. Both side peaks with respect to the central peak is 0.08 or more.

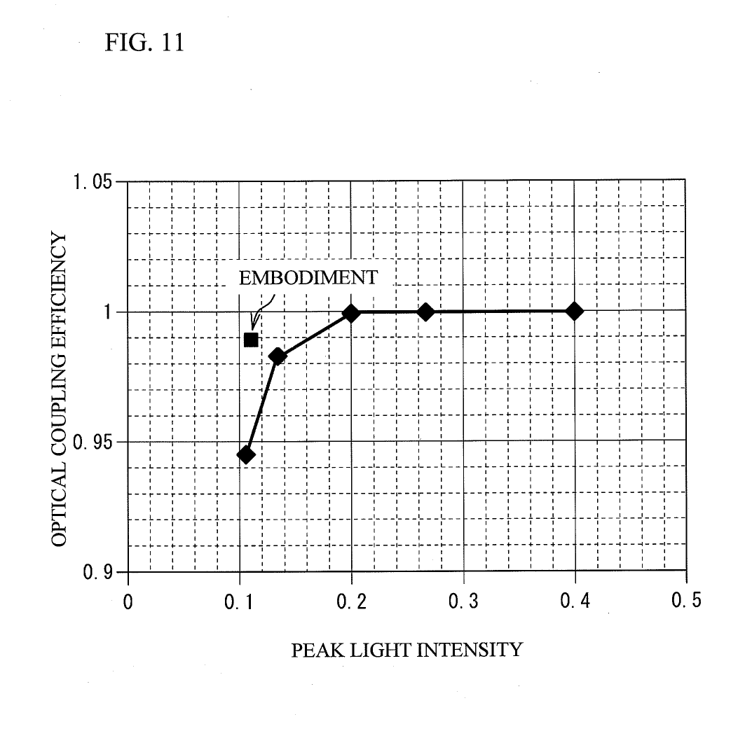

FIG. 11 illustrates the optical coupling efficiency in this case. In FIG. 11, a horizontal axis indicates the peak light intensity, and a vertical axis indicates the optical coupling efficiency. As illustrated in FIG. 11, the peak light intensity is reduced and the reduction of the optical coupling efficiency is restrained, when a plurality of peaks appear in the light intensity distribution.

In the embodiment, the position of the lens 22 and the light-receiving element 33 is determined with respect to the optical axis of the optical fiber 14 so that there is a difference between the phase of the optical signal of the first optical path and the phase of the optical signal of the second optical path and a plurality of peaks light intensity appear in the light-receiving face of the light-receiving element 33. Therefore, restraint of the space-charge effect of the light-receiving element 33 and high optical coupling efficiency of the light-receiving element 33 are achieved.

### First Modified Embodiment

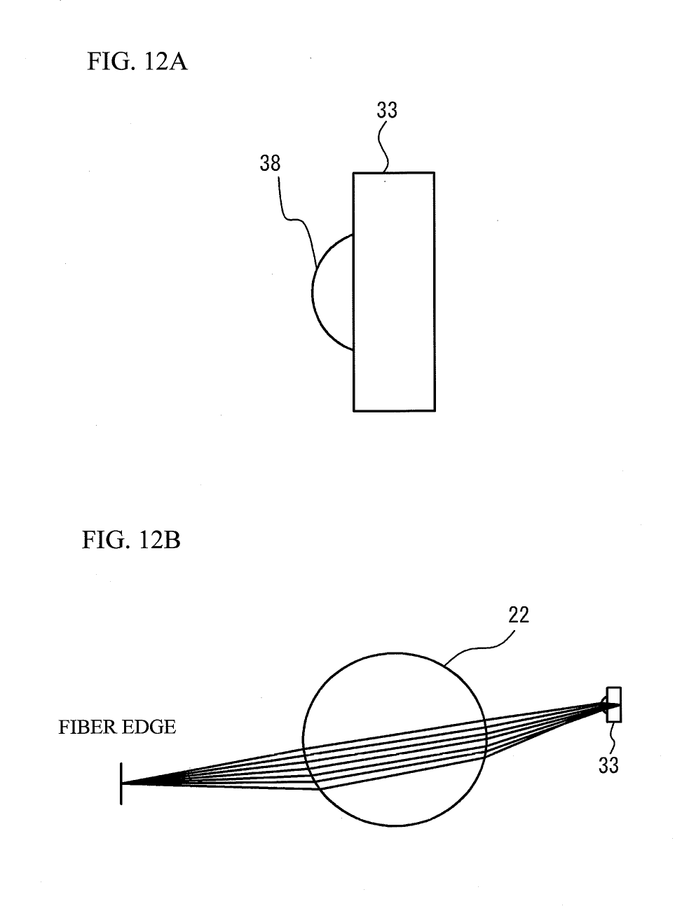

FIG. 12A illustrates another example of a light receiving element. As illustrated in FIG. 12A, a light focus portion 38 having curvature may be monolithically provided on the side of the light-receiving element 33. In this case, as illustrated in FIG. 12B, the light focus portion 38 further collects optical signals received by the light-receiving element 33.

### Second Modified Embodiment

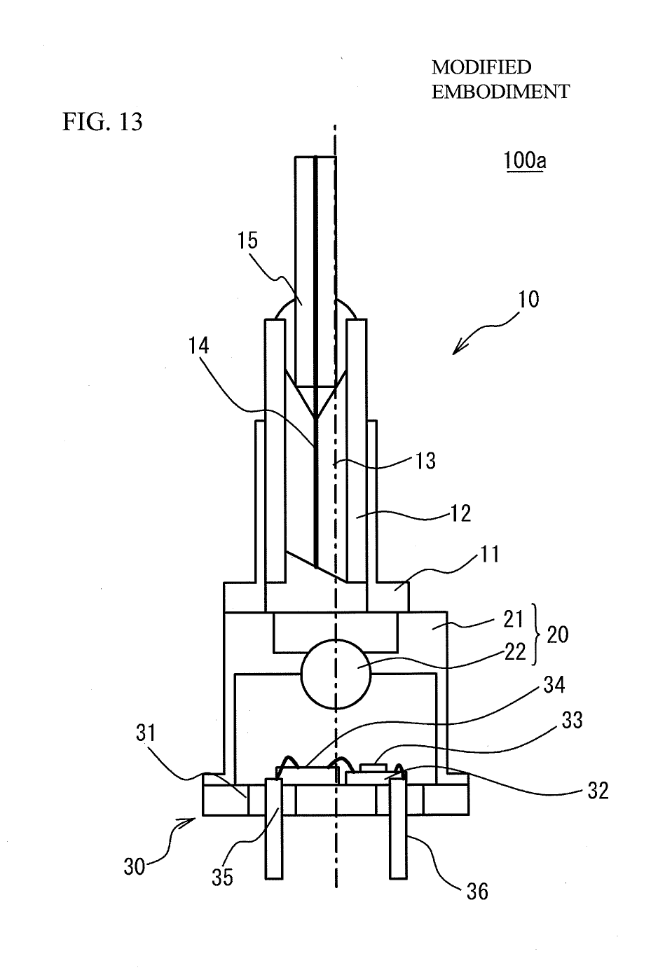

FIG. 13 illustrates a cross sectional view for describing an overall structure of an optical semiconductor device 100a in accordance with a second modified embodiment. As illustrated in FIG. 13, an emission edge of the optical fiber 14 may be cut obliquely with respect to the optical axis of the optical fiber 14. In this case, adjusting an angle between the emission edge of the optical fiber 14 and the optical axis of the optical fiber 14 enlarges the free degree of the position of the optical fiber 14, the lens 22 and the light-receiving element 33. Thus, limitation of component arrangement in the optical semiconductor device 100a is lightened. And, it is possible to restrain incoming of a light reflected by the light-receiving element 33 into the optical fiber 14.

### Experimental Examples

A description will be given of an experimental result of the optical semiconductor device 200 of the comparative example and an experimental result of the optical semiconductor device 100a of the second modified embodiment. Table 1 shows experimental conditions. As shown in Table 1, a spherical lens of material BK-7 having a diameter of 1.5 mm was used as the lens 22. And, an optical fiber, of which angle of a cut-plane of an emission edge is 10 degrees, was used as the optical fiber 14. A distance between the lens 22 and the emission edge of the optical fiber 14 was 0.8 mm. A distance between the lens 22 and the light-receiving element 33 was 2.5 mm. In the comparative example, the optical axis of the optical fiber 14 passes through the center of the lens 22 and is positioned at the center of the light-receiving face of the light-receiving element 33. In the embodiment, the center of the lens 22 has an offset of 0.34 mm with respect to the optical axis of the optical fiber 14. The center of the light-receiving face of the light-receiving element 33 has an offset of 0.55 mm with respect to a position extended from the center of the lens 22 in the optical axis direction.

TABLE 1

| | | COMPARATIVE |
|---|---|---|
| | EMBODIMENT | EXAMPLE |
| TYPE OF LENS | SPHERICAL LENS, DIAMETER OF | |
| | 1.5 mm, MATERIAL BK-7 | |
| DISTANCE FROM LENS | 0.8 mm | |
| TO OPTICAL FIBER | | |
| DISTANCE FROM LENS | 2.5 mm | |
| TO LIGHT-RECEIVING | | |
| ELEMENT | | |
| OFFSET FROM LENS | 0.34 mm | 0 mm |
| TO OPTICAL FIBER | | |
| OFFSET FROM LENS | 0.55 mm | 0 mm |
| TO LIGHT-RECEIVING | | |
| ELEMENT | | |

| | |
|---|---|
| TYPE OF | BACK-FACE ILLUMINATED PIN-PD |
| LIGHT-RECEIVING | INTEGRATED WITH MONO- |
| ELEMENT | LITHIC LENS, ACCEPTANCE |
| | DIAMETER OF 15 μm |
| WAVELENGTH OF | 1310 nm. DFB LASER |
| LIGHT SOURCE | |

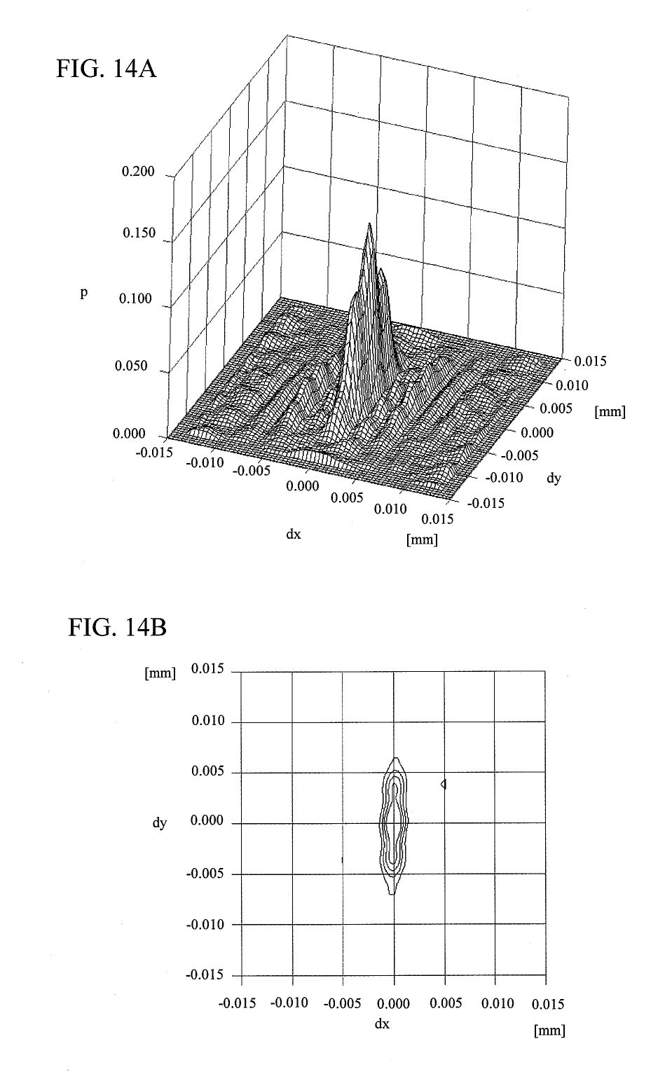

FIG. 14A illustrates three dimensional light intensity distribution of the embodiment. FIG. 14B illustrates contour lines of the light intensity distribution of FIG. 14A. As illustrated in FIG. 14A and FIG. 14B, the light intensity places a disproportionate emphasis on the center of the optical signal. Thus, light intensity off the center of the optical signal is reduced. This is because a plurality of light intensity peaks appear according to the phase difference of the optical signals on a plurality of optical paths in the light-receiving face of the light-receiving element 33.

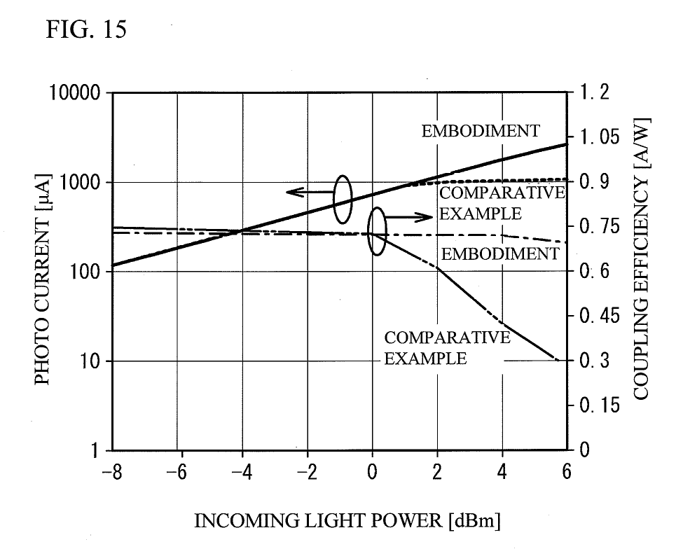

FIG. 15 illustrates the experimental results. In FIG. 15, a horizontal axis indicates optical power (dBm) received by the light-receiving element 33. A left vertical axis indicates photocurrent (μA) obtained through photoelectric conversion. And a right vertical axis indicates optical coupling efficiency (A/W). In the experimental examples of FIG. 15, a target value of the optical coupling efficiency was set to be 0.75 A/W. As illustrated in FIG. 15, in the comparative example, when inputting power exceeds 0 dBm, the photocurrent was saturated and the optical coupling efficiency was reduced. However, in the embodiment, even if the inputting power was +6 dBm, the photocurrent was not saturated and the optical coupling efficiency was not reduced. With the results, it has been demonstrated that the restraint of space-charge effect of a light-receiving element and high optical coupling efficiency of the light-receiving element are achieved when the optical semiconductor device of the embodiment is used.

### Structure of Optical System

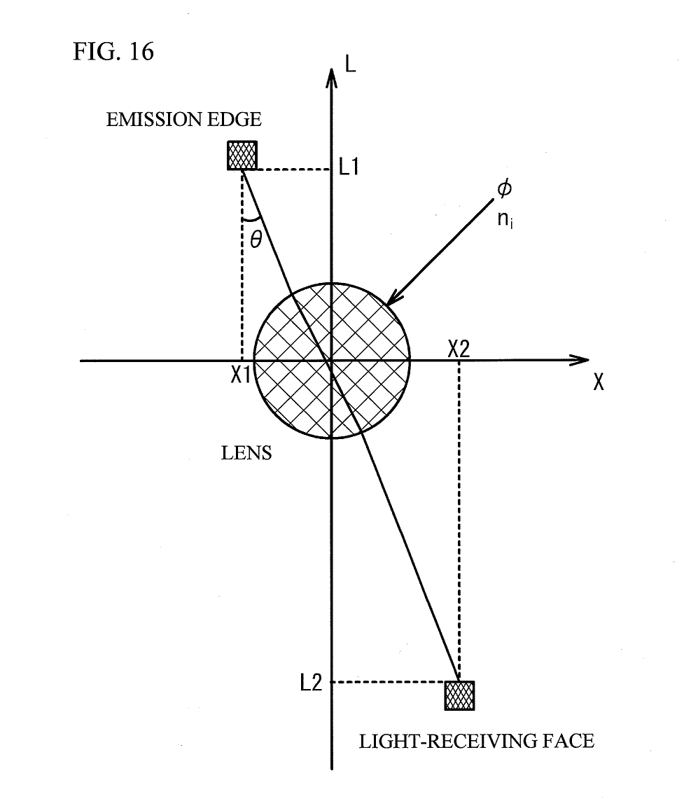

FIG. 16 illustrates an example of a structure of an optical system. FIG. 16 illustrates a central optical axis coupling the emission edge, the lens and the light-receiving face and illustrates a positional relationship of the emission edge and the light-receiving face with respect to the center of the lens. In FIG. 16, an L-direction indicates the optical axis of the optical fiber 14, and an X-direction indicates a position in a face having vertical relationship with the optical axis of the optical fiber 14. “0” indicates an angle between the optical axis of the optical signal emitted from the emission edge of the optical fiber 14 and the optical axis of the optical fiber 14. “φ” indicates the diameter of the lens 22. “nᵢ” indicates refraction index of the lens 22 (approximately 1.5 to 1.6). Here, “L1” indicates a position of the emission edge of the optical fiber 14 in the L-direction. “X1” indicates a position of the emission edge of the optical fiber 14 in the X-direction. “L2” indicates a position of the light-receiving face of the light-receiving element 33 in the L-direction. “X2” indicates a position of the light-receiving face of the light-receiving element 33 in the X-direction.

A description will be given of an example of conditions in which a plurality of peaks appear in the light intensity distribution on the light-receiving face of the light-receiving element 33. The followings are conditions in a case where a wavelength of an optical signal emitted from the optical fiber 14 is 1.2 μm to 1.6 μm. The cut-plane angle means an angle of a cut-plane sloping toward the lens side with respect to the optical axis (the L-direction) of the optical fiber 14. When the cut-plane angle is zero degree, the edge face of the optical fiber 14 is in parallel with the X-direction. These conditions can be obtained by adjusting each parameter and determining favorable conditions with optical analysis simulation.

(Condition 1) A plurality of peaks appear in the light intensity distribution on the light-receiving face of the light-receiving element 33 when the cut-plane angle of the emission edge of the optical fiber 14 is 6 degrees, the diameter of the lens 22 is 1.5 mm, and L2/X2 is 5.0. (Condition 2) A plurality of peaks appear in the light intensity distribution on the light-receiving face of the light-receiving element 33 when the cut-plane angle of the emission edge of the optical fiber 14 is 10 degrees, the diameter of the lens 22 is 1.0 mm, and L2/X2 is 2.6. (Condition 3) A plurality of peaks appear in the light intensity distribution on the light-receiving face of the light-receiving element 33 when the cut-plane angle of the emission edge of the optical fiber 14 is 10 degrees, the diameter of the lens 22 is 1.5 mm, and L2/X2 is 4.5. (Condition 4) A plurality of peaks appear in the light intensity distribution on the light-receiving face of the light-receiving element 33 when the cut-plane angle of the emission edge of the optical fiber 14 is 10 degrees, the diameter of the lens 22 is 2.0 mm, and L2/X2 is 5.2.

The present invention is not limited to the specifically disclosed embodiments and variations but may include other embodiments and variations without departing from the scope of the present invention.

What is claimed is:

1. A light-receiving device comprising:
a lens; and
a light-receiving element optically coupled to the lens,
a plurality of optical path divided by the lens crossing each other in a position of between the lens and the light-receiving element.

2. The light-receiving device as claimed in claim 1, wherein the incoming light has a plurality of peak intensities on a light-receiving face of the light-receiving element.

3. The light-receiving device as claimed in claim 1, wherein:
an optical signal input to the lens is emitted from an optical fiber; and
an emission edge of the optical fiber is oblique with respect to an optical axis of the optical fiber.

4. The light-receiving device as claimed in claim 1, wherein the lens is a spherical lens.

5. The light-receiving device as claimed in claim 1 wherein the light-receiving element has a light focus portion having a curvature on the light incoming side.

6. The light-receiving device as claimed in claim 3, wherein:
the optical signal input to the lens is emitted from the optical fiber; and
a light-receiving face of the light-receiving element is oblique with respect to a place that is vertical with respect to an axis coupling a center of the optical fiber and a center of the lens.

7. The light-receiving device as claimed in claim 1, wherein a wavelength of the incoming light is 1.2 μm or more and 1.6 μm or less.

8. The light-receiving device as claimed in claim 3 wherein:
a cut-plane of an emission edge of the optical fiber is formed with a sloping face; and
the cut-plane has an angle of 6 degrees to 10 degrees with respect to an optical axis at a vertical edge face of the optical fiber.

9. The light-receiving device as claimed in claim 1, wherein a diameter of the lens is within a range of 1.0 m to 2.0 mm.

10. The light-receiving device as claimed in claim 1, wherein:
the lens is integrally held together with a stem having an element-mounting face on which the light-receiving element is mounted; and
a center of a light-receiving face of the light-receiving element has an offset with respect to an axis that is vertical with respect to the element-mounting face of the stem passing through the center of the lens.

11. A light-receiving device comprising:
a lens; and
a light-receiving element optically coupled to the lens,
an incoming light through the lens having a plurality of peak intensities on a light-receiving face of the light-receiving element.

12. The light-receiving device as claimed in claim 11, wherein:
an optical signal input to the lens is emitted from an optical fiber; and
an emission edge of the optical fiber is oblique with respect to an optical axis of the optical fiber.

13. The light-receiving device as claimed in claim 11, wherein the lens is a spherical lens.

14. The light-receiving device as claimed in claim 11 wherein the light-receiving element has a light focus portion having a curvature on the light incoming side.

15. The light-receiving device as claimed in claim 12, wherein:
the optical signal input to the lens is emitted from the optical fiber; and
a light-receiving face of the light-receiving element is oblique with respect to a place that is vertical with respect to an axis coupling a center of the optical fiber ad a center of the lens.

16. The light-receiving device as claimed in claim 11, wherein a wavelength of the incoming light is 1.2 μm or more and 1.6 μm or less.

17. The light-receiving device as claimed in claim 12 wherein:
a cut-plane of an emission edge of the optical fiber has an angle of 6 degrees to 10 degrees with respect to an optical axis at a vertical edge face of the optical fiber.

18. The light-receiving device as claimed in claim 11, wherein a diameter of the lens is within a range of 1.0 m to 2.0 mm.

19. The light-receiving device as claimed in claim 11, wherein:
the lens is integrally held together with a stem having an element-mounting face on which the light-receiving element is mounted; and
a center of a light-receiving face of the light-receiving element has an offset with respect to an axis that is vertical with respect to the element-mounting face of the stem passing through the center of the lens.
